(19) United States
(12) Patent Application Publication
(10) Pub. No.: US 2025/0288838 A1
(43) Pub. Date: Sep. 18, 2025

(54) COOLANT INJECTION FIRE SUPPRESSION SYSTEM

(71) Applicant: WHITE WATER SOLUTIONS, INC., Patterson, CA (US)

(72) Inventors: Marvin Cain, SR., Patterson, CA (US); Moses Cain, III, Hayward, CA (US); Airis Dominic Smith, San Ramon, CA (US)

(21) Appl. No.: 19/227,210

(22) Filed: Jun. 3, 2025

Related U.S. Application Data
(63) Continuation-in-part of application No. 18/069,214, filed on Dec. 20, 2022.
(60) Provisional application No. 63/293,713, filed on Dec. 24, 2021.

(51) Int. Cl. A62C 33/00; A62C 31/00

(52) U.S. Cl. CPC A62C 33/00; A62C 31/005

(57) ABSTRACT

A fire suppression system includes a coaxial coolant infusion hose assembly. The assembly includes an outer fire hose comprising a male adapter, a female adapter, and a main hose body coupled to the male adapter and the female adapter, wherein water is configured to flow through the male adapter, through the main hose body and out the female adapter. The hose assembly also includes an inner coolant hose comprising a pair of female fittings coupled together by a coolant tube, wherein the inner coolant hose fits coaxially within the outer fire hose, and wherein the inner coolant hose is longer than the outer fire hose, and wherein coolant flows through the inner coolant hose. The coolant is infused into the water inside a mixing chamber within a nozzle housing.

### CROSS REFERENCE TO RELATED APPLICATIONS

This application is a continuation in part and claims the benefit of U.S. non-provisional application Ser. No. 18/069,214 filed Dec. 20, 2022 entitled “Coolant Injection Nozzle for Fire Suppression”, which is a non-provisional of and claims the benefit of U.S. Provisional Application No. 63/293,713 filed Dec. 24, 2021 entitled “Coolant Injection Nozzle for Fire Suppression”, which are incorporated in their entirety by this reference.

### BACKGROUND

The present invention relates to efficient systems and methods for fire suppression using water together with a coolant.

Most traditional firefighting equipment is primarily based on water, because water is more readily available, non-polluting, and relatively inexpensive. Generally, the effectiveness of a fire suppressing stream of water depends on several physics' principles, including the specific heat of water and the latent heat of evaporation of water. In other words, the rate and amount of heat removed from the target is determined by the volume and the ambient temperature of the fire suppressing stream of water.

The primary object of fire suppression is to remove heat as fast as possible from the target and/or to starve the target of its oxygen supply. If heat is removed faster than the target on fire can generate, then the temperature can be reduced below the temperature at which combustion can continue (flashpoint), i.e., try to extinguish the fire before the fuel is exhausted. In other words, the flashpoint is the lowest temperature at which something will burn. In the case of wood that temperature is about 600 degrees Fahrenheit, noting that moisture inside the wood is also a factor.

In addition to temperature requirements for a fire to remain stable, combustion requires the chemical reaction between the fuel source, and oxygen from the air. Water can act as a smothering agent, but it is also possible to otherwise remove or displace the oxygen from around a flame and effectively halt the chemical reaction. This can cause suppression of the flames even when the fuel is above the flashpoint temperature. Once the flames are thus extinguished, it is much easier to reduce the fuel temperature as the exothermic reaction is no longer counteracting the cooling process.

In sum, the fire suppression effectiveness of a specific volume of water is highly dependent on the temperature of the water and the availability of oxygen for the fuel, which in turn is also dependent on the ambient temperature. In the hot summer months when most wildfires occur, this is a very significant issue.

It is therefore apparent that an urgent need exists for substantially enhancing the effectiveness of a given volume of water as a fire suppressor. Such improvements will enable firefighters to more quickly and effectively extinguish fires.

### SUMMARY

To achieve the foregoing and in accordance with the present invention, systems and methods for fire suppression using water with a coolant is provided. In particular these systems and methods includes the introduction of a coaxially oriented hose assembly.

In some embodiment, the coaxial coolant infusion hose assembly includes an outer fire hose comprising a male adapter configure to reversibly couple to water source, a coolant introduction adapter, or a second outer fire hose; a female adapter configured to reversibly couple to a nozzle assembly or a third fire hose; and a main hose body coupled to the male adapter and the female adapter, wherein water is configured to flow through the male adapter, through the main hose body and out the female adapter. The male adapter and the female adapter are 2.5″ threaded adapters. The hose assembly also includes an inner coolant hose comprising a pair of female fittings coupled together by a coolant tube, wherein the inner coolant hose fits coaxially within the outer fire hose, and wherein the inner coolant hose is longer than the outer fire hose, and wherein coolant flows through the inner coolant hose. In some cases, one of the female fittings is configured to reversibly couple to a coolant injection adapter, while the other female fitting is configured to couple to a Coolant Infusion Spray Nozzle (CISN) assembly, wherein the CISN assembly further comprises a nozzle housing configured to house the coolant infuser, and wherein the coolant is infused into the water inside a mixing chamber within the nozzle housing. In some cases, the inner coolant hose is approximately three inches longer than the outer fire hose.

In some embodiments, the coolant from a coolant source includes liquid nitrogen or another liquified inert gas. The coolant tube is a solid steel tubing in some embodiments. The solid steel tubing is thin walled, allowing for the inner coolant hose to remain partially flexible. In other embodiments, the coolant tube is a braided steel hose with an inner rubber tube.

The fire suppression system may also include a Coolant Introduction Adapter Cap (CIAC) assembly configured to supply the water and the coolant to the coaxial coolant infusion hose assembly, and wherein the CIAC assembly includes a housing having a first interface and a second interface, wherein the first interface is configured to operatively couple the CIAC assembly to a water source, and wherein the second interface is configured to operatively couple the CIAC assembly to the coaxial coolant infusion hose assembly, and a coolant elbow configured to direct the coolant from the coolant source toward the coaxial coolant infusion hose assembly.

In yet other embodiments, a stationary fire suppression system is also provided which supplies a mixture of coolant and water to a building sprinkler system. Such a fire suppression system includes a coolant tank coupled to a coolant line, a coolant line valve coupled to the coolant line, a coolant line adapter coupled to the coolant line and a building sprinkler system, a flow sensor disposed in the building sprinkler system, wherein the flow sensor detects the flow of water through the building sprinkler system and causes the coolant line valve to open, thereby releasing coolant from the coolant source, through the coolant line and into the building sprinkler system, and at least one sprinkler head for releasing the water and coolant mixture into a building where a flame is present.

Again, the coolant from the coolant tank includes liquid nitrogen or another inert liquified gas. The system may also include a regulator disposed in the coolant line, wherein the regulator restricts the coolant flow. In some cases the regulator is a dynamic regulator that varies the flow of coolant into the sprinkler system responsive to water flow rate: more coolant is released into the sprinkler system as the water flow rate increases.

The system may also include at least one occupancy sensor disposed near each sprinkler head. The at least one occupancy sensor couples to the coolant valve, and when the occupancy sensor detects a human in the building, it prevents the coolant valve from releasing the coolant into the sprinkler system. The occupancy sensor may be a motion detector, or an optical system.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIGS. 1A-1B are perspective views illustrating deployments of a portable embodiment of a Coolant Infusion Spray Nozzle (“CISN”) coupled to a Coolant Introduction Adapter Cap (“CIAC”) via a fire suppression hose, in accordance with the present invention;

FIG. 2 is a perspective view illustrating deployment of a vehicular-based embodiment of the CISN of FIG. 1A;

FIG. 3 is a cross-sectional view illustrating the CISN and CIAC of FIG. 1A;

FIGS. 4A-4C are perspective, front and cross-sectional views of the CISN of FIG. 1A;

FIGS. 5A-5E illustrate various components of the CISN of FIG. 1A;

FIGS. 6A-6C depict an exemplary inlet cap for the CISN of FIG. 1A;

FIGS. 7A-7B depict exemplary nozzle positioning tab, coolant infusion nozzle, coolant nozzle reducer and coolant pipe for the CISN of FIG. 1A;

FIGS. 8A-8C depict the coolant infusion nozzle for the CISN of FIG. 1A;

FIGS. 9A-9B depict the nozzle positioning tab for the CISN of FIG. 1A;

FIGS. 10A-10B depict an exemplary coolant spray head for the CISN of FIG. 1A;

FIGS. 11A-11C are perspective, side and cross-sectional views of the CIAC of FIG. 1A;

FIGS. 12A-12D depict an exemplary coolant elbow for the CIAC of FIG. 1A;

FIG. 13 is a cross-sectional view illustrating coolant injection into the water flow for the CISN of FIG. 1A;

FIG. 14 is a perspective view illustrating deployment of another vehicular-based embodiment of the CISN of FIG. 1A;

FIGS. 15A-15C illustrate deployment of an aircraft-based embodiment of the CISN of FIG. 1A;

FIG. 16 illustrates an example cross-sectional view of a fire hose of FIG. 1A;

FIG. 17 illustrates an example cross-sectional view of an inner coolant hose of FIG. 1A;

FIGS. 18A and 18B illustrate a side view and a cross sectional view of the coolant injection fire suppression hose assembly; and

FIG. 19 provides a block diagram of a structural coolant enhanced fire suppression sprinkler system.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “always,” “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to systems and methods for substantially enhancing the effectiveness of water as a fire suppressor, by infusing a coolant into the water stream. In some embodiments, the coolant includes a Liquid Nitrogen (LN), or another liquid inert gas, compound which not only super cools the water being emitted from the nozzle, it also acts to displace ambient oxygen from around the flames, thereby halting the chemical reaction.

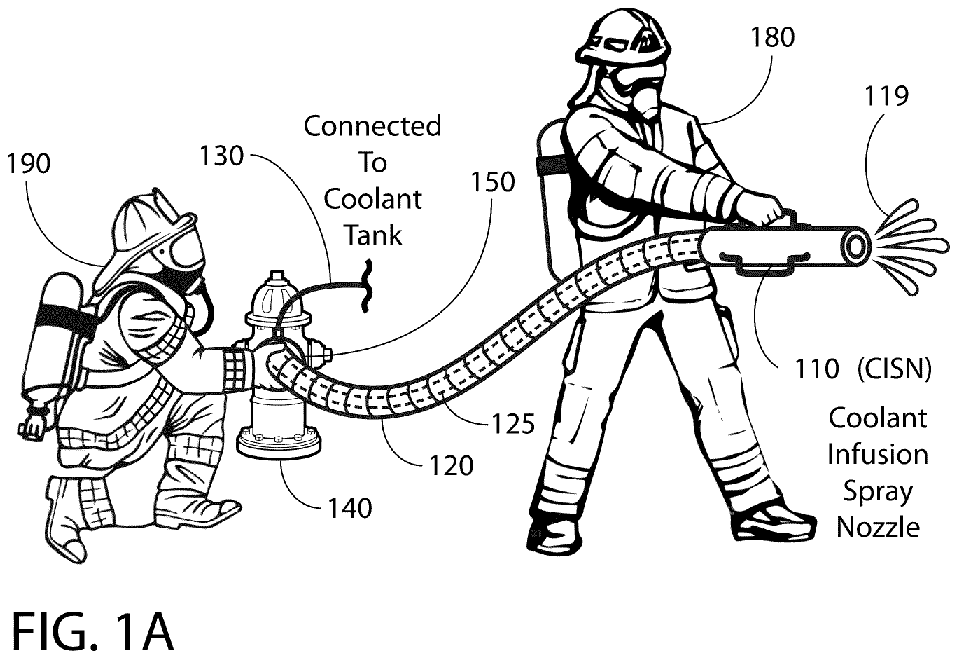

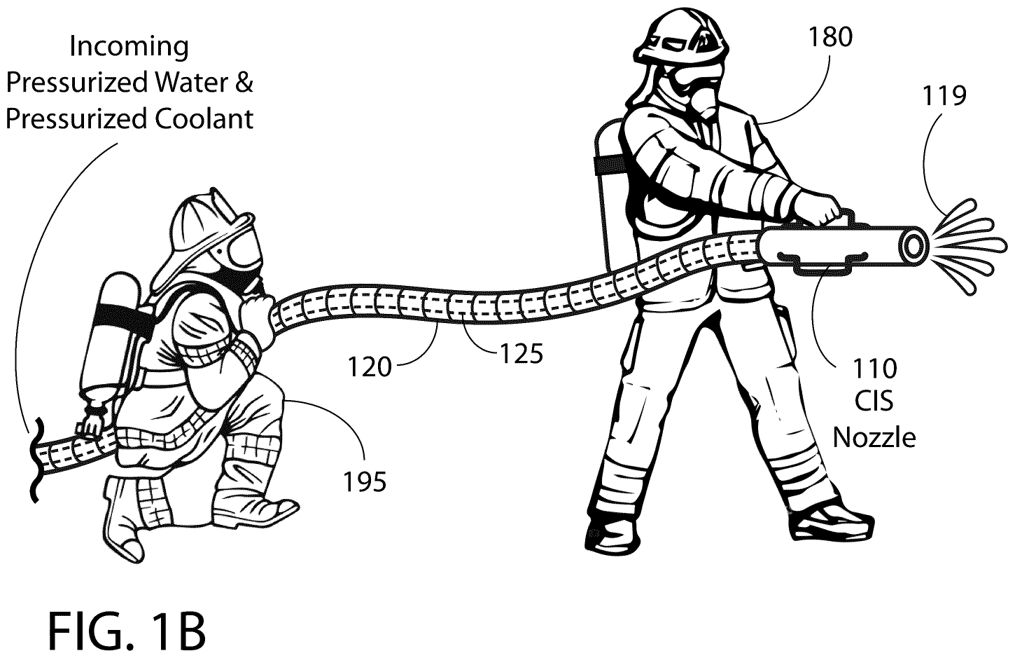

To facilitate discussion, perspective view FIG. 1A illustrates deployment of an exemplary portable Coolant Infusion Spray Nozzle (“CISN”) assembly 110 coupled to an exemplary Coolant Introduction Adapter Cap (“CIAC”) assembly 150 via a fire suppression hose 120, in accordance with one embodiment of the present invention.

In this embodiment, the CIAC assembly 150 is operatively coupled to a fire hydrant 140. A supply coolant hose 130 couples the CIAC assembly 150 to a coolant supply source (not shown) and provides coolant destined for the CISN assembly 110. Note that an inner (smaller diameter) coolant hose 125, located inside fire suppression hose 120, supplies coolant from the CIAC assembly 150 to the CISN assembly 110. Suitable coolants include liquified inert gases such as liquid nitrogen, argon and carbon dioxide.

In this exemplary deployment, a primary firefighter 180 grips one or more handle(s) of the CISN assembly 110 to direct a mixed stream of water and coolant 119 at a target object (not shown). A safety firefighter 190 is tasked with controlling the flow rate of the coolant, using, for example, one or more valves (not shown).

FIG. 1B illustrates another deployment of a firefighting team, with an additional firefighter 195 playing the role of an extra safety officer assisting the primary fighter 180. In this deployment, the additional firefighter 195, located close to the primary firefighter 180, is able to assist the primary firefighter 180 control the water hose 120 by absorbing some of the nozzle back forces, especially the nozzle recoil forces during opening and closing of the water supply valve (not shown).

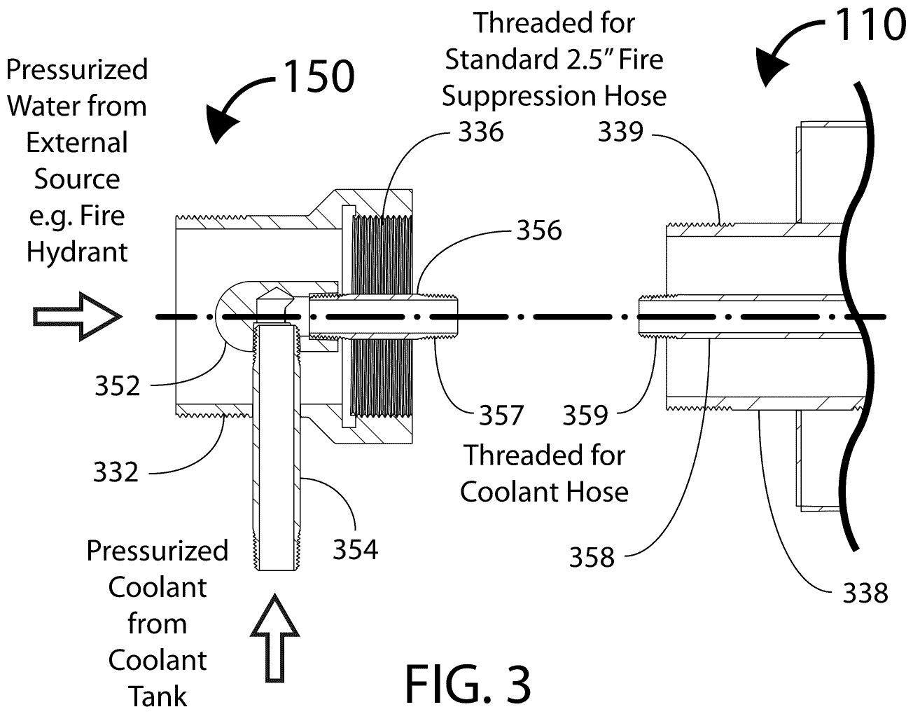

FIG. 3 is a cross-sectional view illustrating the interoperation of CISN assembly 110 with CIAC assembly 150 and depicts the respective threaded sections for interfacing with an intercoupling inner coolant hose (see hose 125 of FIG. 1A) housed within an intercoupling outer fire suppression hose (see hose 120 of FIG. 1A).

In this example, threaded section 359 of a coolant inlet, e.g., pipe 358, is intended to be inline with and operatively coupled to threaded section 357 of a coolant supply pipe 356 via inner coolant hose 125, while threaded section 336 of CIAC assembly 150 is intended to be inline with and operatively coupled to threaded section 339 of a water inlet, e.g., pipe 338, via fire suppression hose 120. Also shown is a coolant elbow 352 operatively coupling coolant supply pipe 356 to a coolant tank feed pipe 354.

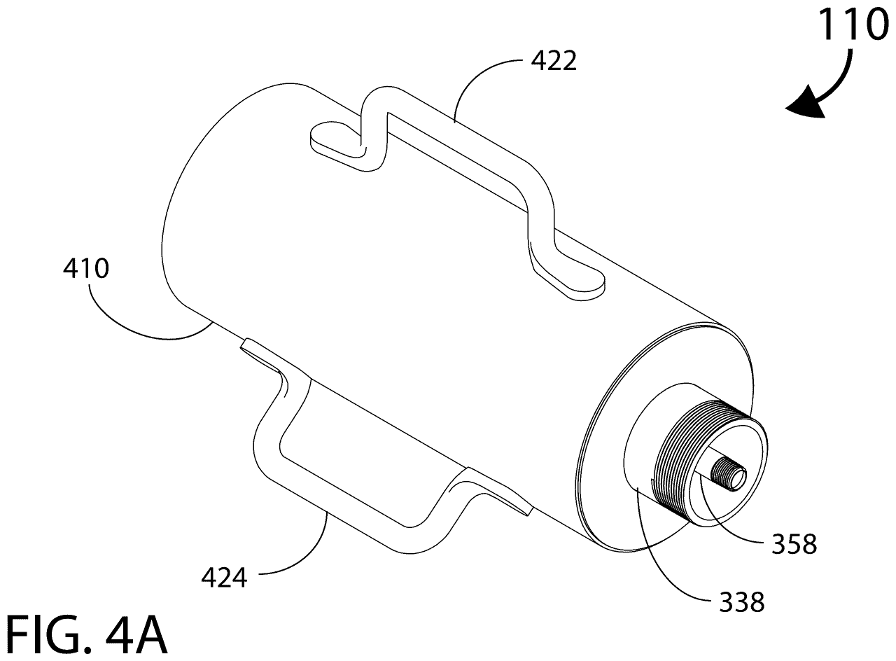

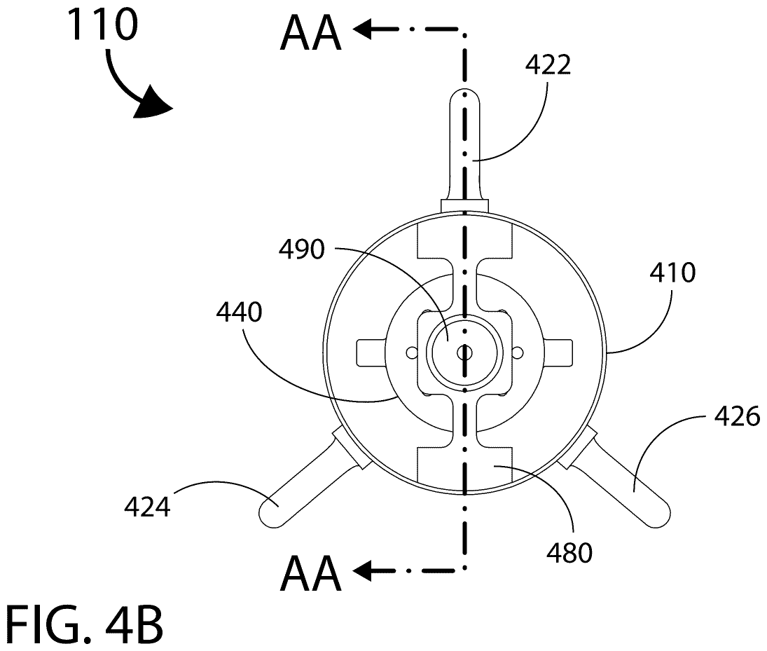

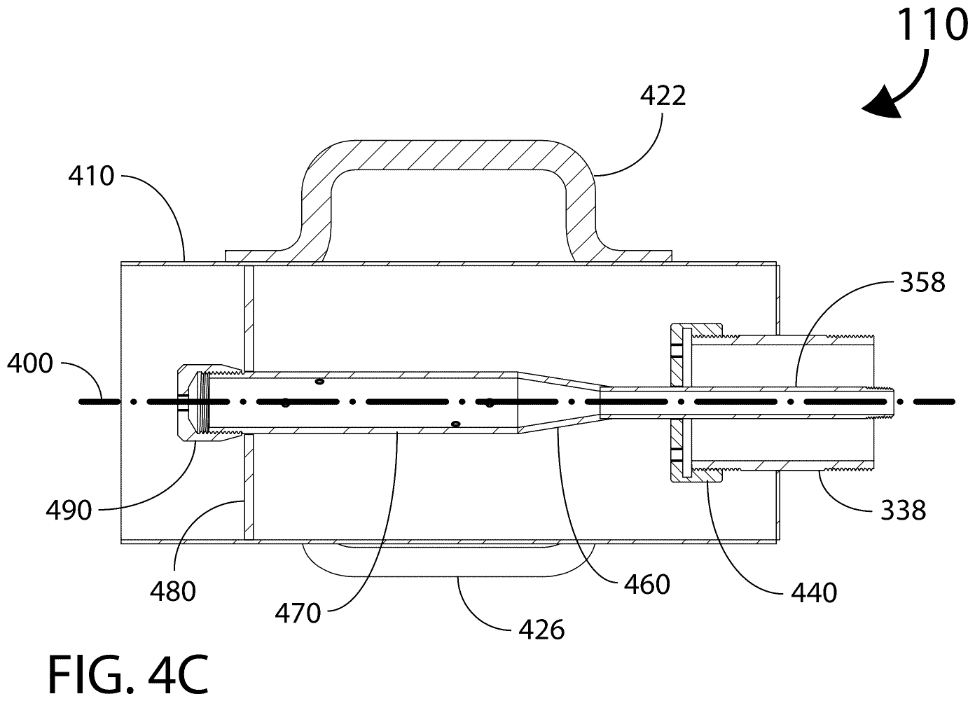

Referring now to FIGS. 4A-4C are a perspective view, a front view and a cross-sectional view AA-AA, respectively, of the CISN assembly 110 which includes a nozzle housing 410, the water inlet pipe 338, an inlet cap 440, the coolant inlet pipe 358, a coolant nozzle reducer 460, a coolant infusion nozzle 470, a nozzle positioning tab 480 and a coolant spray head 490.

In this embodiment, during manufacture, the water inlet pipe 338, the coolant nozzle reducer 460 and the coolant infusion nozzle 470 are permanently secured to each other, and are arranged inline relative to each other along central axis 400. In addition, the coolant infusion nozzle 470 is aligned to and secured inside housing 410 by the nozzle positioning tab 480. Inlet cap 440 is securely screwed onto one end of the water inlet pipe 338, and likewise coolant spray head 490 is securely screwed onto one end of the coolant infusion nozzle 470.

In some embodiments, housing 410 is coupled to one or more external handles, e.g., handles 422, 424, 426, as depicted by FIGS. 4A and 4B. In this embodiment, these three handles 422, 424, 426 are distributed 120 degrees relative their respective adjacent handles thereby also enabling two adjacent handles to also function as stabilizing legs whenever the CISN assembly 110 is placed on a substantially horizontal surface.

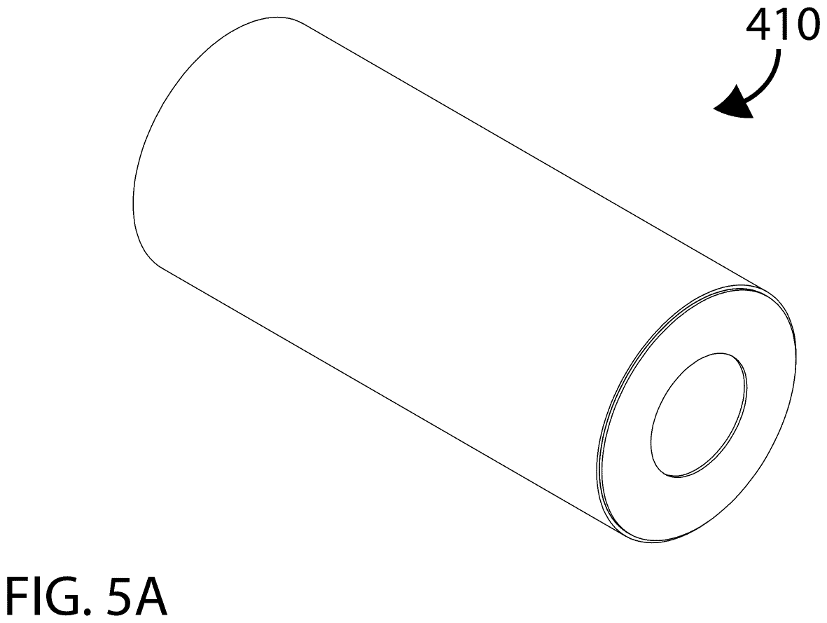

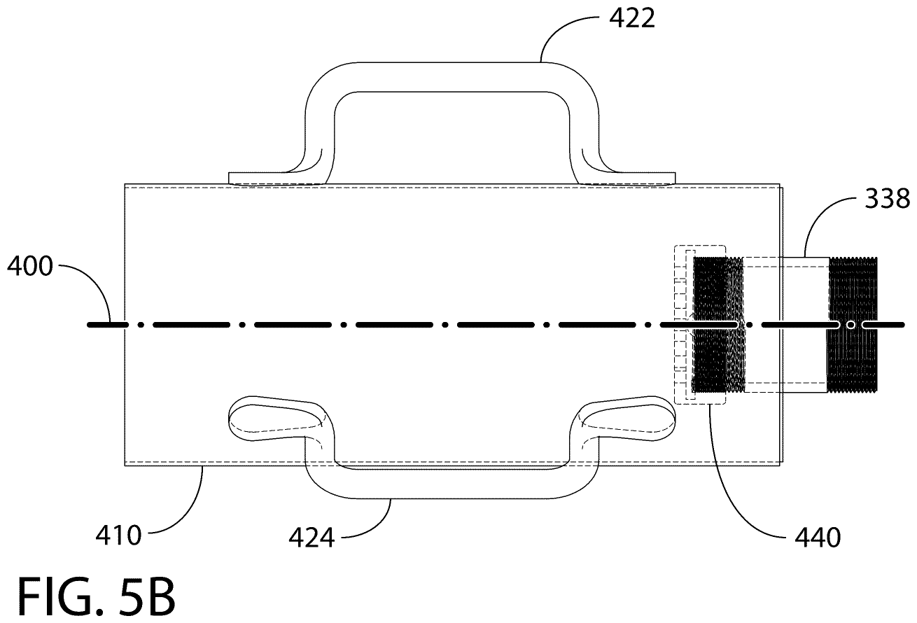

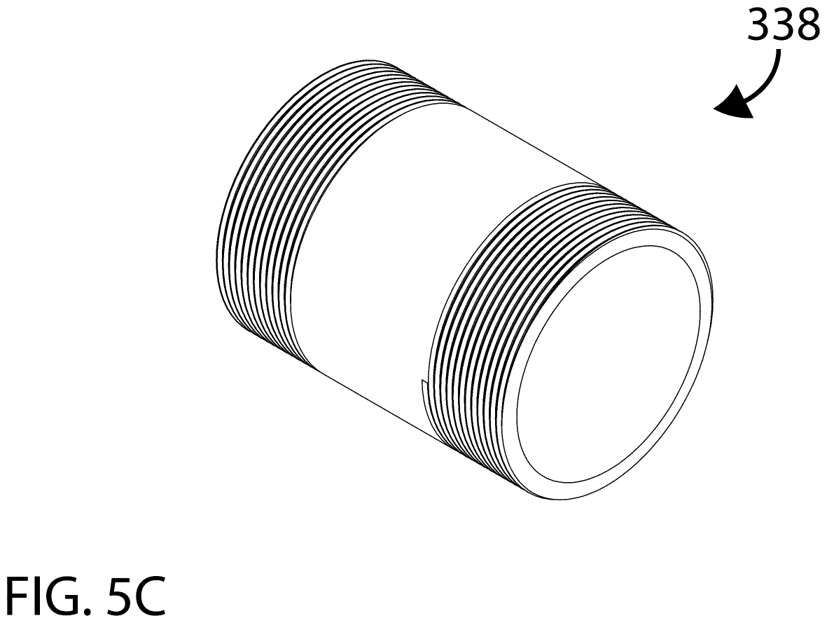

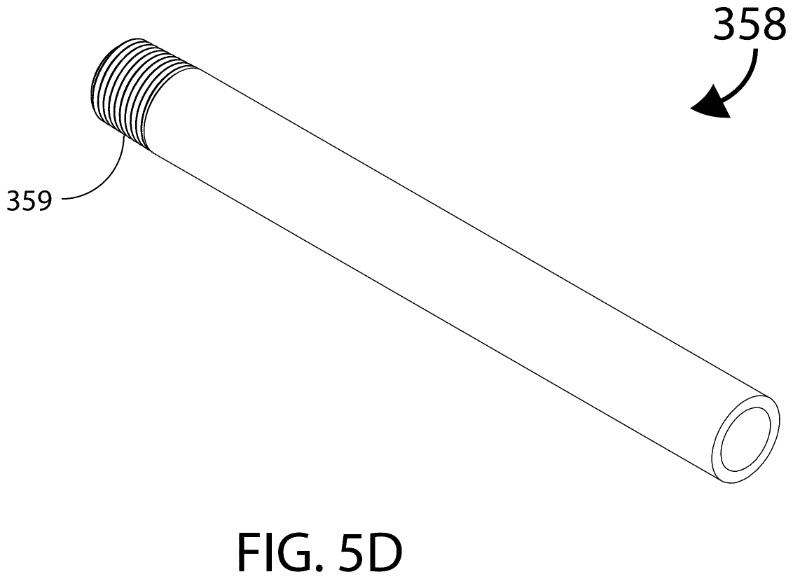

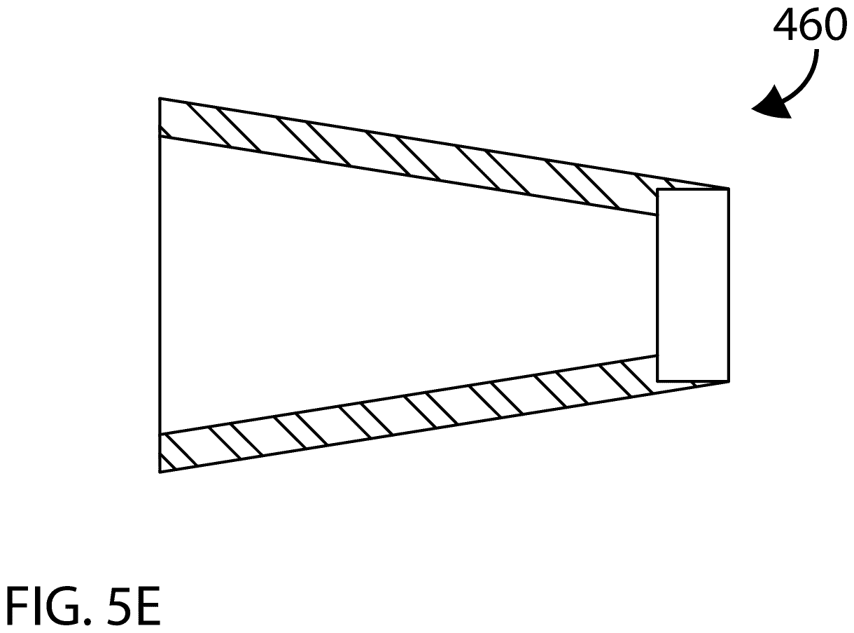

FIG. 5A-5E provide additional views of the components of CISN assembly 110. For example, FIG. 5A depicts a perspective view of the nozzle housing 410, while FIG. 5B depicts a cross-sectional view of nozzle housing 410 together with handles 422, 424, and with the inlet cap 440 coupled to the water inlet pipe 338. In addition, FIGS. 5C, 5D and 5E show an enlarged perspective view of the water inlet pipe 338, an enlarged perspective view of the coolant inlet pipe 358, and a cross-sectional view of the coolant nozzle reducer 460, respectively.

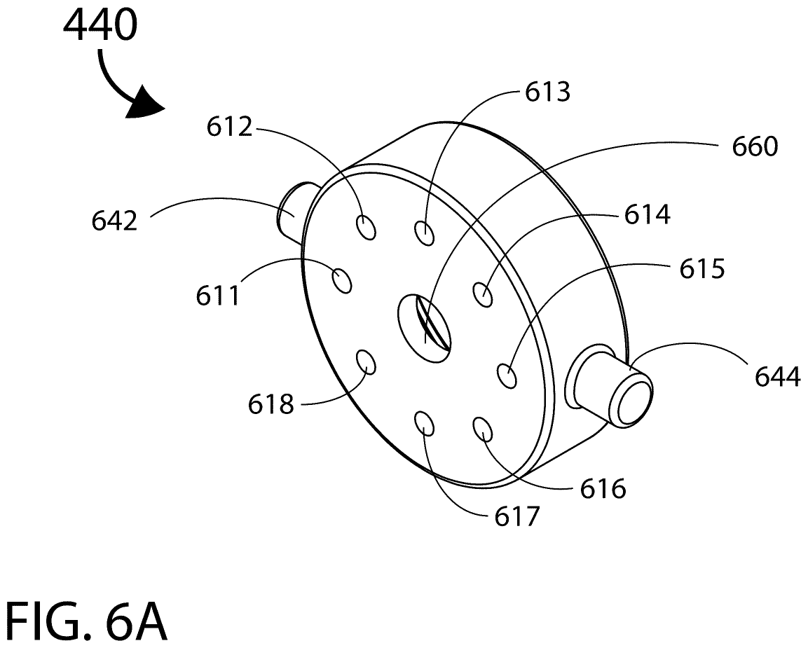

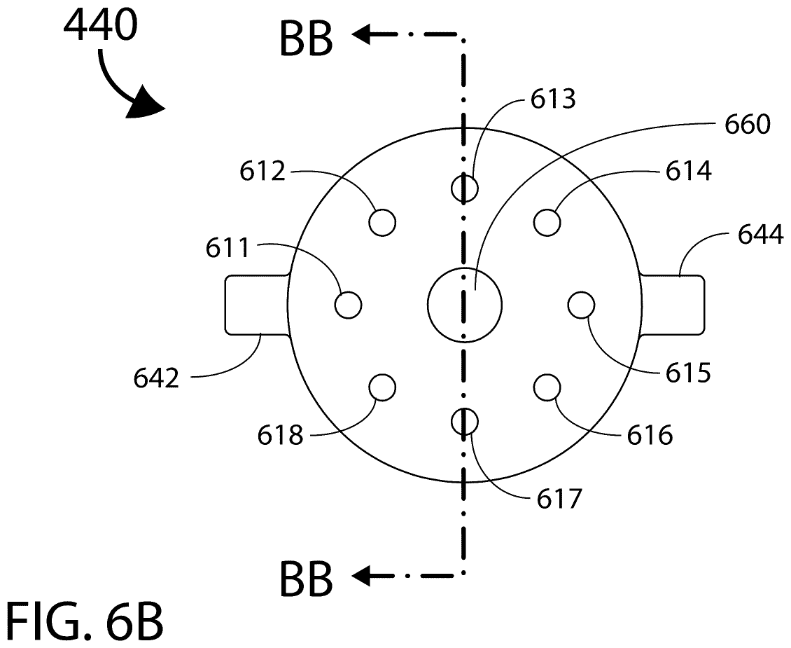

FIGS. 6A-6C depict a perspective view, a front view and a cross-sectional view BB-BB, respectively, of the inlet cap 440 of the CISN assembly 110. In this embodiment, inlet cap 440 includes a plurality of concentric water ejection holes 611, 612, 613, 614, 615, 616, 617, 618, arranged in a radial pattern around a central water ejection 660. The diameter of the water ejection holes can be between 0.2 inches and 0.3 inches, e.g., 0.25 inches. Inlet cap 440 also includes a couple of opposing knobs 642, 644 configured to provide mechanical leverage when tightening or loosening the internal threads 680 of inlet cap 440 with respect to the water inlet pipe 338 (see also FIG. 5B).

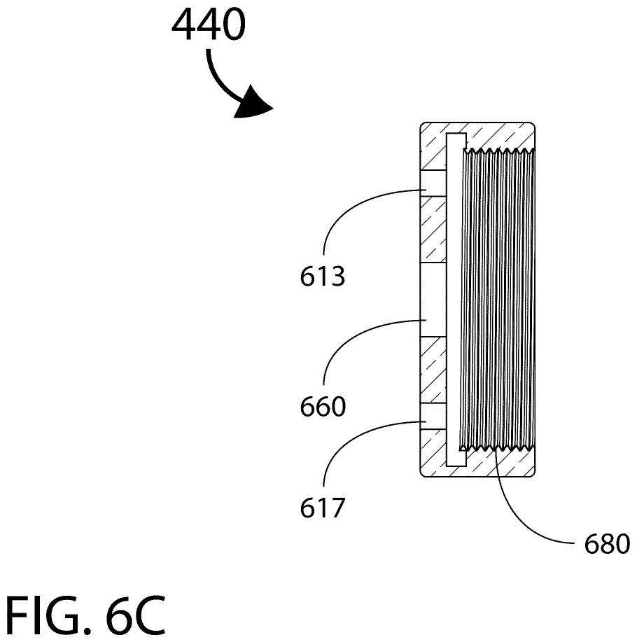

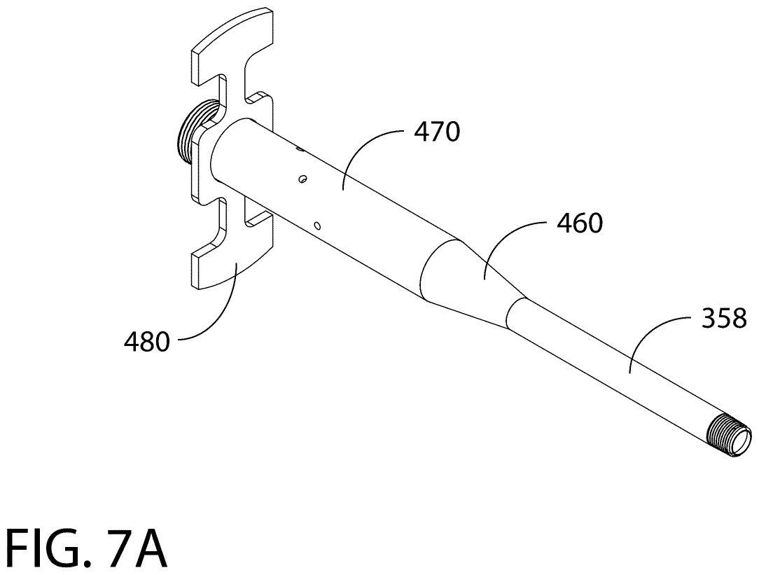

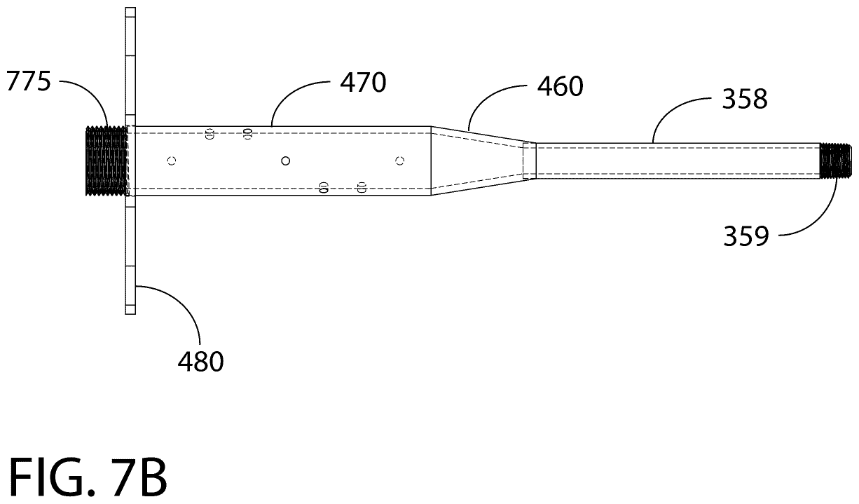

As discussed above and as shown in greater detail, FIGS. 7A-7B are perspective and side views depicting the nozzle positioning tab 480, the coolant infusion nozzle 470, the coolant nozzle reducer 460 and the coolant inlet pipe 358 for the CISN assembly 110. Note that the coolant infusion nozzle 470 includes a threaded forward-facing section 775 configured to be secured to the coolant spray head 490. In this embodiment, the coolant infusion nozzle 470, the coolant nozzle reducer 460 and the coolant inlet pipe 358 are secured to each other using one or more suitable joining techniques, including welding, brazing, adhesive, and/or screw threads.

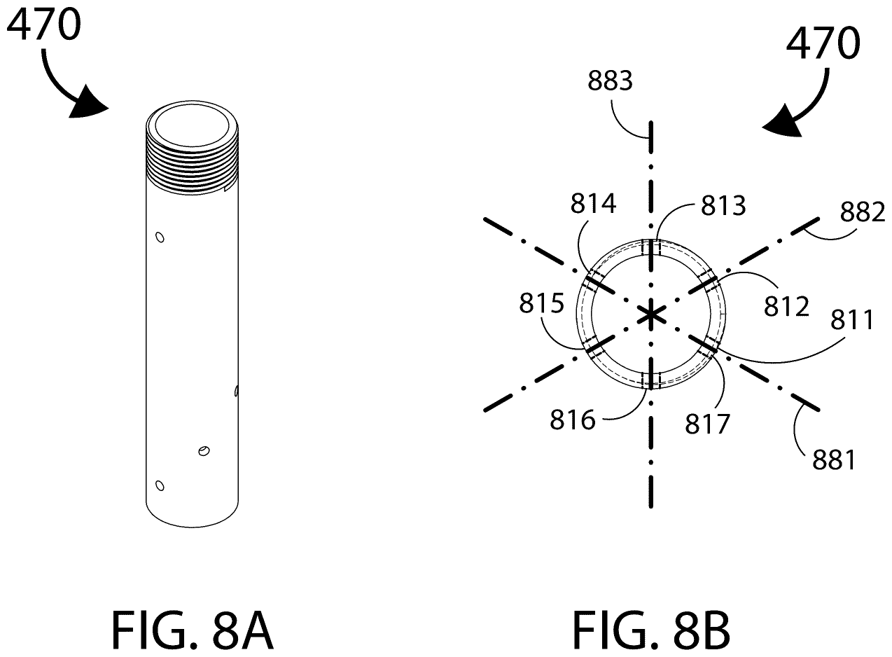

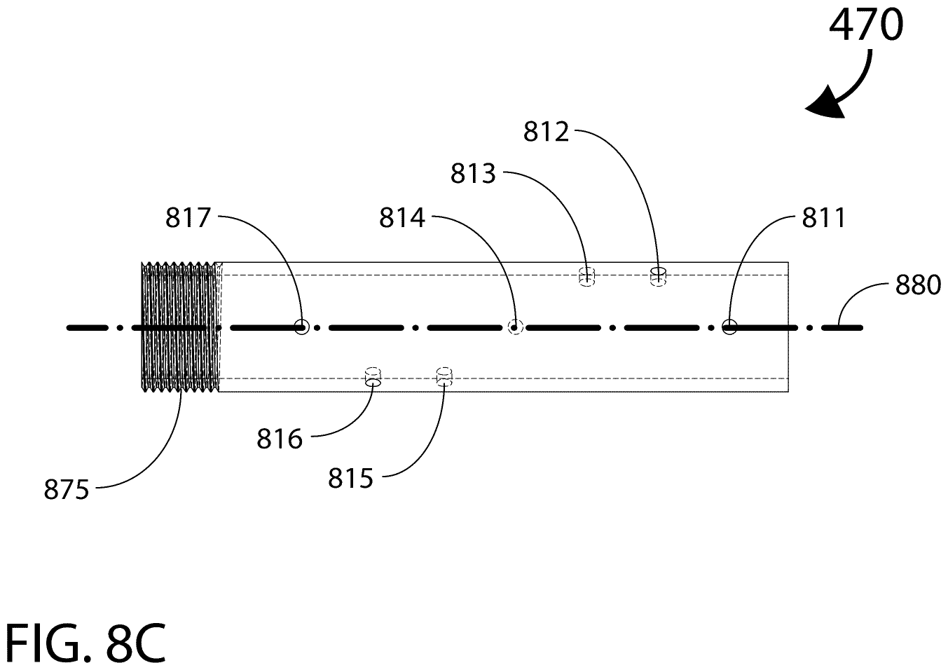

FIGS. 8A-8C are a perspective view, a front view, and a side view, respectively, depicting the exemplary coolant infusion nozzle 470 for the CISN assembly 110. In this embodiment, nozzle 470 includes a spiral series of coolant infusion apertures 811, 812, 813, 814, 815, 816 & 817, arranged symmetrically along three axis 881, 882, & 883 dissecting nozzle 470. The diameter of coolant infusion apertures 811 . . . 817 can be between 0.05 inch and 0.20 inch, e.g., a diameter of 0.15 inch.

For example, as shown in FIGS. 8C and 8B, these holes 811, 812, 813, 814, 815, 816 & 817 are substantially evenly distributed along a horizontal central axis 880 and also radially, e.g., at 60 degrees from their adjacent holes, with the first hole 811 and the last hole 817 aligned with respect to each other along axis 881. Many other variations and permutations of infusion hole arrangements are contemplated without substantially deviating from the objectives of the present invention.

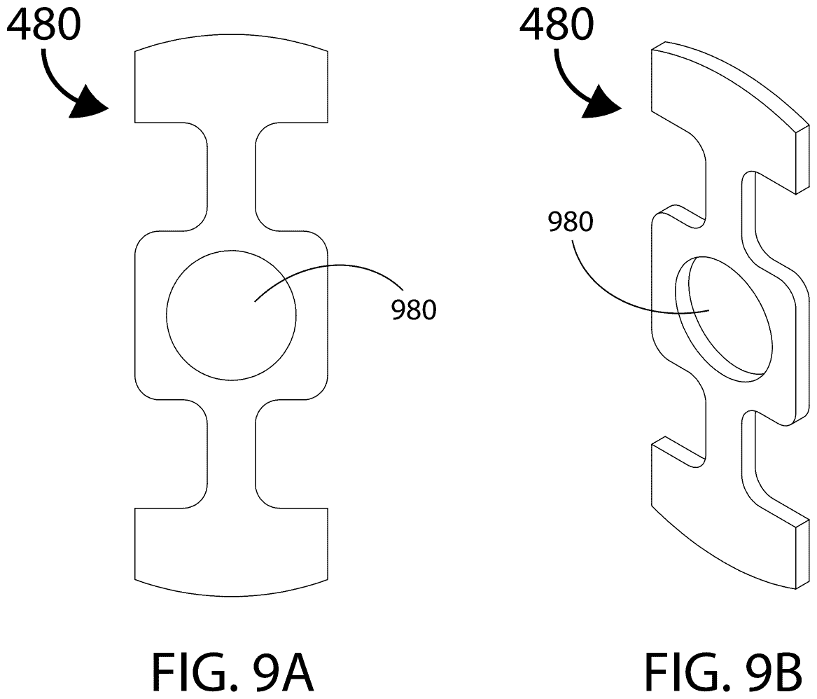

FIGS. 9A-9B are front and perspective views illustrating the nozzle positioning tab 480 for the CISN assembly 110. Referring also to FIGS. 7A-7B, in this embodiment, positioning tab 480 includes a through hole 980 configured to receive the threaded portion 775 of the coolant infusion nozzle 470, during construction of the CISN assembly 110.

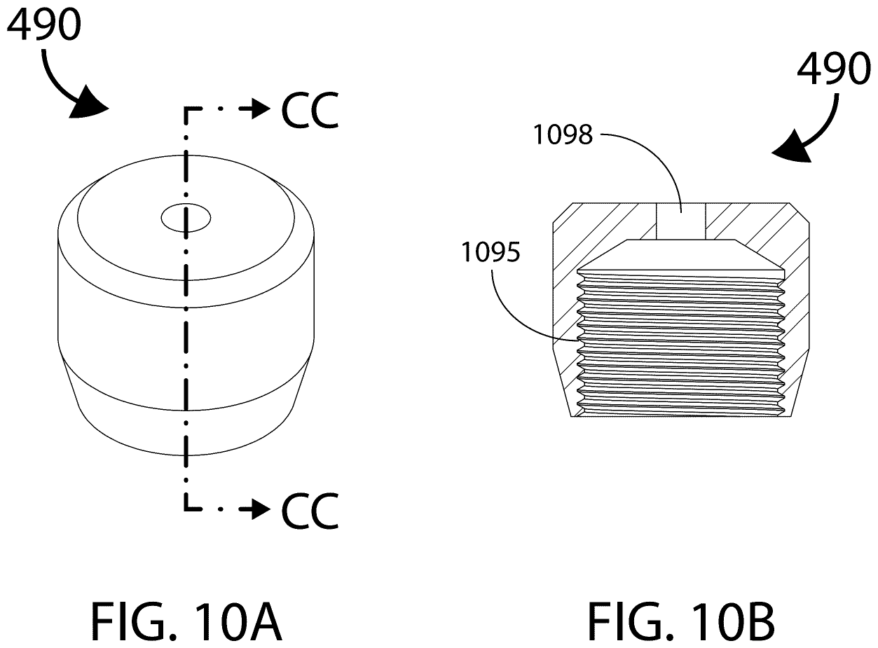

In some embodiments, as depicted in FIGS. 10A and 10B, a perspective view and a cross-sectional view CC-CC, the coolant spray head 490 of CISN assembly 110 also includes a coolant ejection hole 1098 aligned with central horizontal axis 400 (see also FIG. 4). The diameter of coolant ejection hole 1098 can be between 0.2 inches and 0.4 inches, e.g., 0.31 inches. Spray head also includes internal threads 1095 for engaging with threaded end 775 of coolant infusion nozzle 470 as depicted in FIG. 7B.

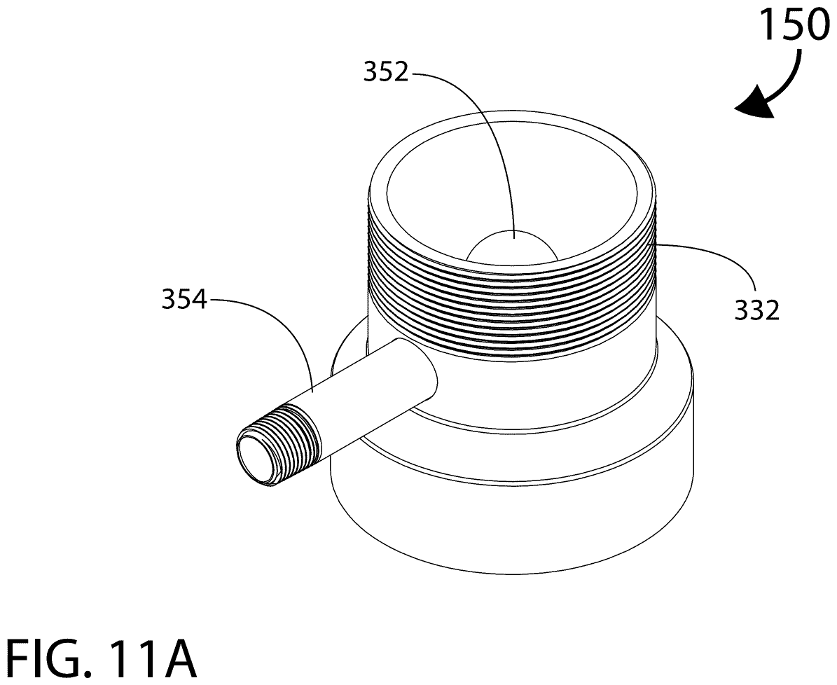

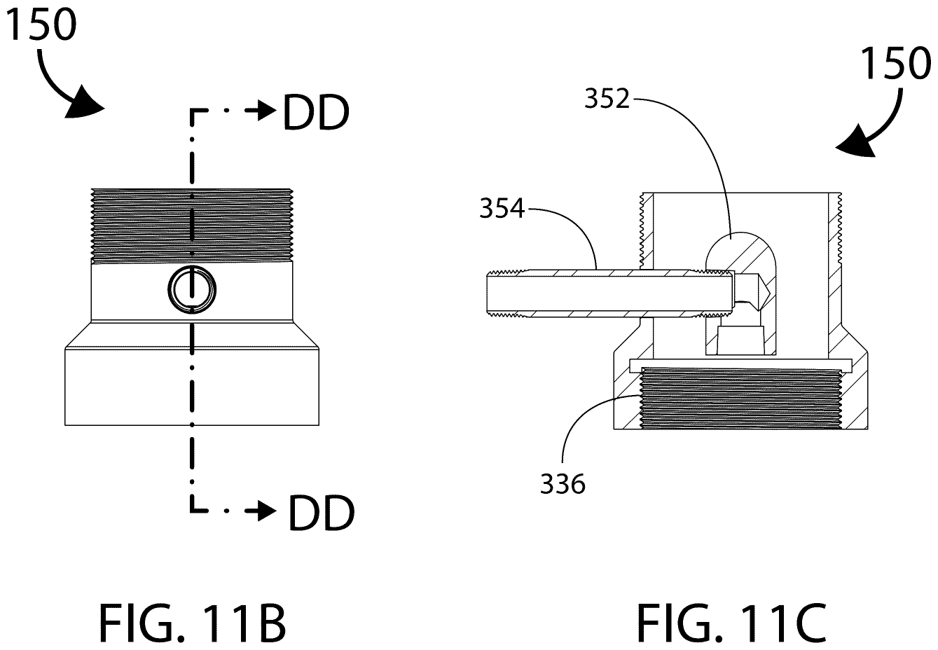

Referring back to the cross-sectional view of FIG. 3 and also FIGS. 11A-11C, an enlarged perspective view, a side view and a cross-sectional view DD-DD of an exemplary embodiment of the CIAC assembly 150, the functionality of each component of CIAC assembly 150 are now described in greater detail. In this embodiment, the external threads 332 of CIAC assembly 150 are configured to be coupled to a water source, such as fire hydrant 140 of FIG. 1A.

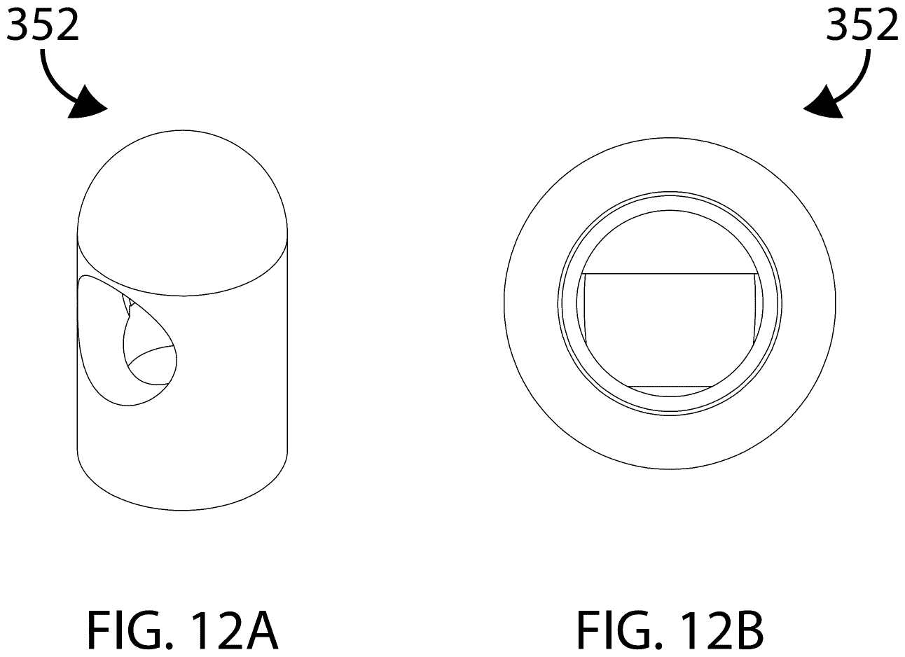

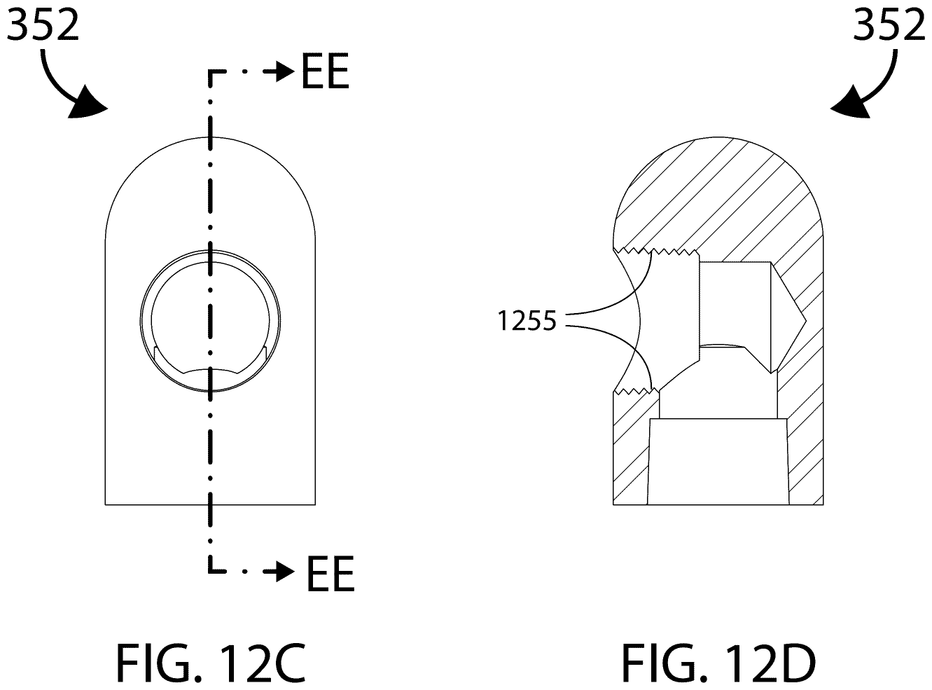

As discussed above, in this exemplary deployment depicted by FIG. 1A, the coolant tank feed pipe 354 is configured to be coupled the coolant elbow 352 in order to be able to provide a consistent supply of coolant from an external coolant tank (not shown) to coolant supply pipe 356, which in turn provides the coolant to the CISN assembly 110 being hand held by firefighter 180. FIGS. 12A, 12B, 12C and 12D are a perspective view, a bottom view, a side view and a cross-sectional view EE-EE, respectively, depicting the coolant elbow 352 for the CIAC assembly 150 in greater detail. As shown in FIG. 12D, coolant elbow 352 includes internal threads 1255 configured to engage one end of the coolant tank feed pipe 354 depicted in FIG. 3.

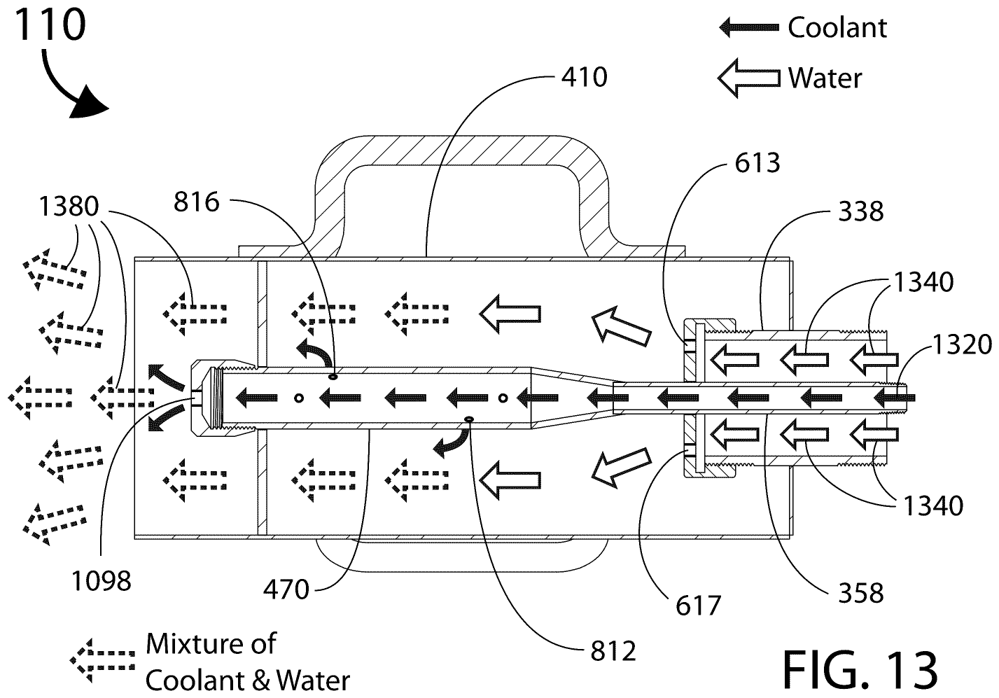

Referring also back to FIG. 4C, FIG. 13 is a cross-sectional view illustrating the infusion of a suitable coolant into the water flow for the CISN assembly 110. From right to left, water 1340 is introduced under pressure (ideally between 18-22 pounds per square inch (psi), e.g., 20 psi) into the water inlet pipe 338 from a suitable water source (not shown), such as a fire engine or a fire hydrant. In turn, the water is then introduced into a mixing chamber 410, as defined by the interior of nozzle housing 410, via the concentric plurality of water ejection holes including holes 613 & 617.

In this embodiment, coolant 1320 is also introduced simultaneously under pressure (ideally between 375-425 psi, e.g., 400 psi) from a suitable coolant source (not shown) into coolant inlet pipe 358, and then into coolant nozzle reducer 460. Next, the coolant is introduced into coolant infusion nozzle 470, where it can be infused under pressure into the water in the mixing chamber 410 via a plurality of coolant infusion holes 811, 812, 813, 814, 815, 816, 817 arranged in a spiral, like the steps of a spiral stairway.

In some embodiments, the resulting mixture 1380 of water and coolant is expelled from the mixing chamber 410 and is also joined by a jet of coolant sprayed from the infusion nozzle 470 via the coolant ejection hole 1098 of coolant spray head 490. The movement of the water/coolant solution prevents freezing of the supercooled water. As the coolant comes into contact with the relatively warm water, the coolant will boil, thus significantly reducing the temperature of the resulting coolant and water mixture. The resulting mixture will also froth due to the expanding coolant, creating a smothering effect on any flames the mixture is sprayed upon.

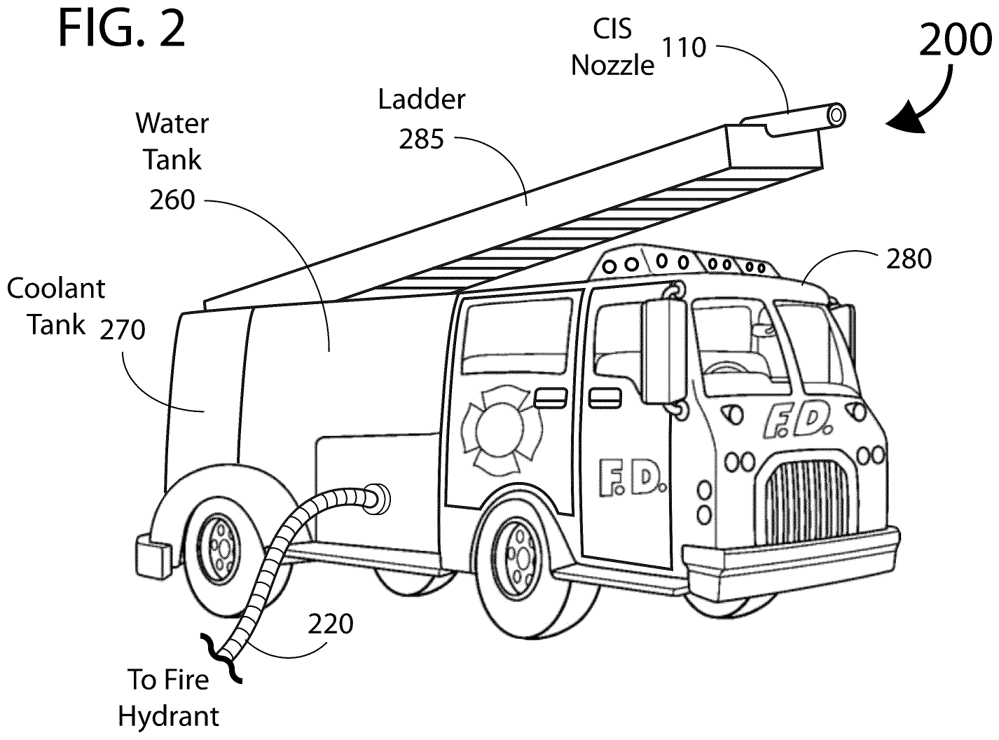

Many modifications, additions and/or deployment models, such as vehicular-based and aircraft-based deployment platforms, are possible. For example, FIG. 2 is a perspective view illustrating an exemplary deployment of a vehicular-based embodiment 200 that includes the Coolant Infusion Spray Nozzle (“CISN”) 110 depicted by FIGS. 4A-C. This exemplary embodiment 200 includes a fire truck 280 providing a platform for an extendable ladder 285, a water tank 260, a coolant tank 270, and the CISN 110. For extended operations, a water hose 220 enables the fire truck 280 to be resupplied by an external water source, such as a fire hydrant (not shown).

In some embodiments, the vehicular-based CISN 110 is deployed at the top of the ladder 285 so as to maximize its reach and range. CISN 110 can either be manually controlled by a firefighter (not shown) perched at the top of ladder 285 behind CISN 110. Alternatively, CISN 110 can be controlled by a local operator located inside fire truck 280 and/or remotely controlled by a remote operator located at an incident command post.

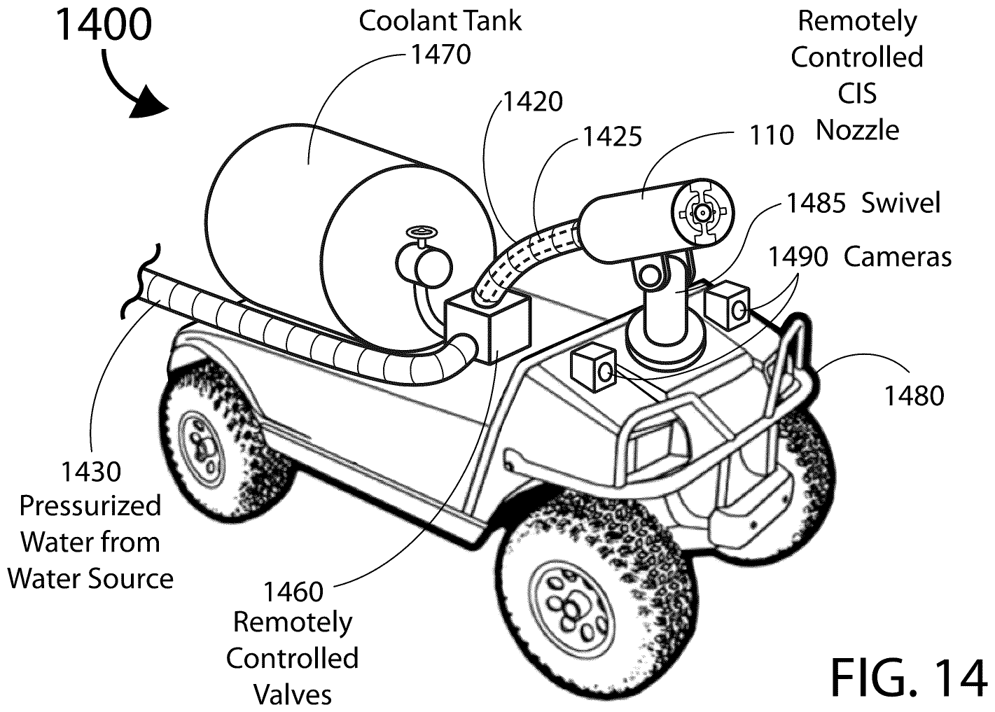

FIG. 14 is a perspective view illustrating another exemplary deployment of a vehicular-based embodiment 1400 that includes the CISN 110 depicted by FIGS. 4A-C. This exemplary embodiment 1400 includes a remotely controlled all-wheel-drive all-terrain-vehicle (“ATV”) 1480 providing a compact platform for a coolant tank 1470, remotely controlled valves 1460, and camera(s) 1490. The CISN 110 can be mounted on a remotely controlled swivel 1485.

The CISN 110 is operatively coupled to the remotely controlled valves 1460 by a water hose 1420 and a coolant 1425 located inside the water hose 1420. Because of the limited physical size and laden weight capacity of the ATV 1480, a water hose 1430 supplies water from an external water source, such as a fire hydrant (not shown) or a fire truck (not shown). Such a compact platform is advantageous, as ATV 1480 is able to navigate narrow footpaths and/or steep terrain. Furthermore, compact ATV 1480 is also capable of entering a variety of buildings such as warehouses, factories, barns and stables, while not directly endangering the firefighting operator who is able to remotely control the CISN 110 from a relatively safe distance, since it is well known that fire-damaged buildings are prone to collapse.

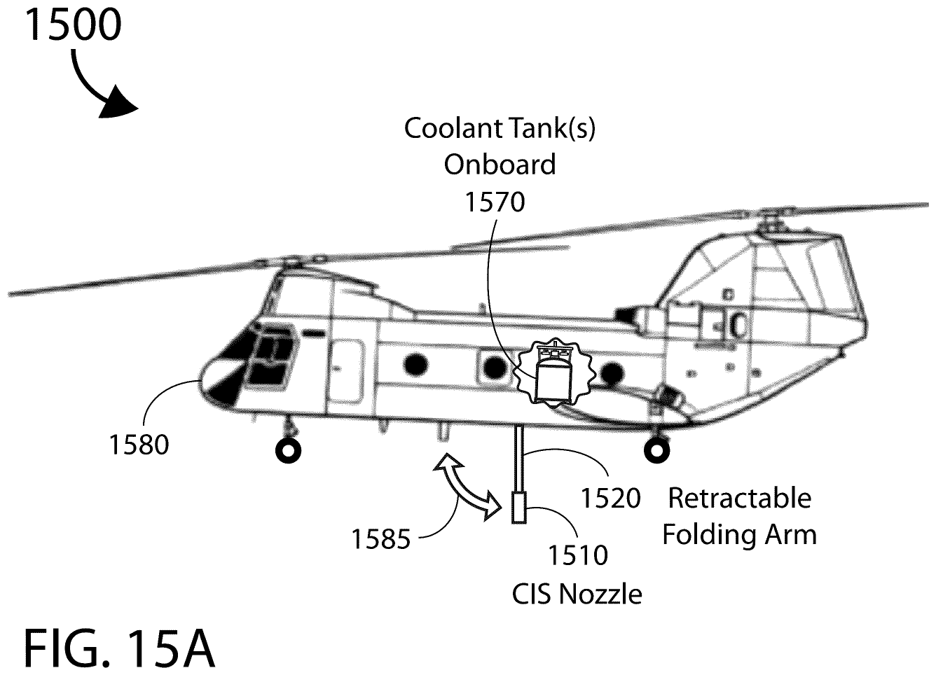

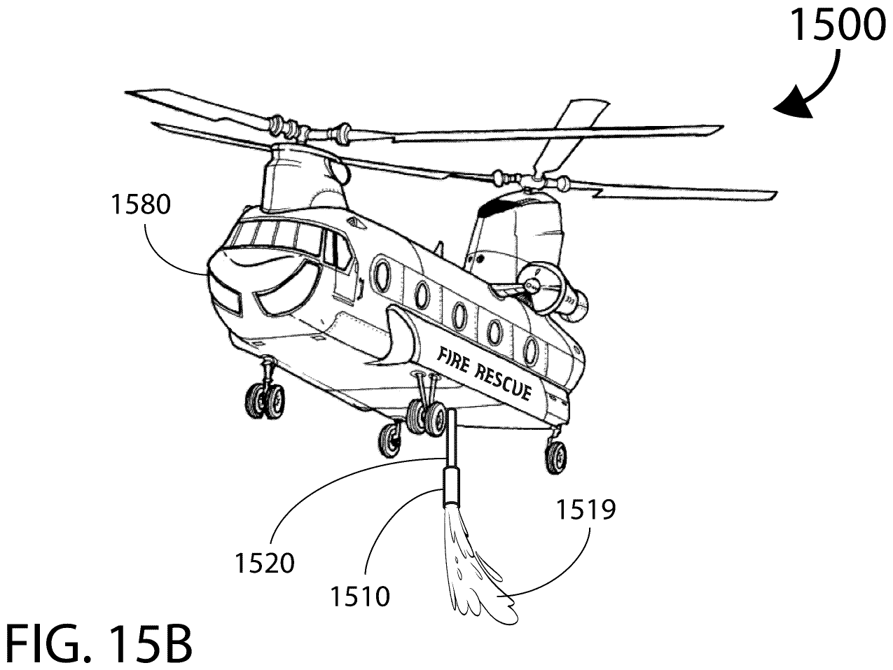

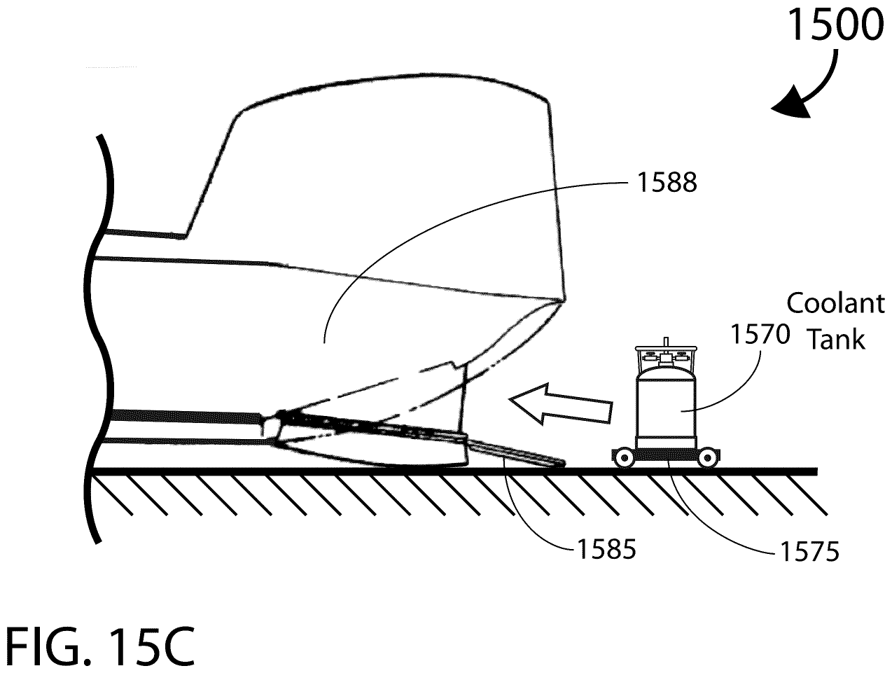

FIGS. 15A-15C are perspective and side views illustrating an exemplary deployment of an aircraft-based embodiment 1500 that includes an aerial version 1510 of the CISN 110 depicted by FIGS. 4A-C. This exemplary embodiment 1500 includes a fixed-wing aircraft 1580 such as a Chinook 47, a twin-engine, tandem rotor, heavy-lift behemoth that has a potential payload of over 20,000 pounds. A typical Chinook 47 equipped for fire-fighting is capable of carrying up to 3,000 gallons of water. In this embodiment, helicopter 1580 provides an aerial platform for one or more water tanks (not shown), one or more onboard coolant tanks 1570, and an aerial CISN 1510 mounted on a retractable arm 1520. The arm 1520 can be folded to fit horizontally under the belly of helicopter 1580 prior to deployment (see directional arrow 1585).

As shown in the side view of FIG. 15C, because the rear tandem rotor is mounted high on its airframe, amongst fixed-wing aircrafts, helicopter 1580 offers a relatively high and wide loading ramp 1585 for quickly loading coolant tank 1570 into its large interior cargo bay 1588, and subsequently quickly offloading empty coolant tank(s).

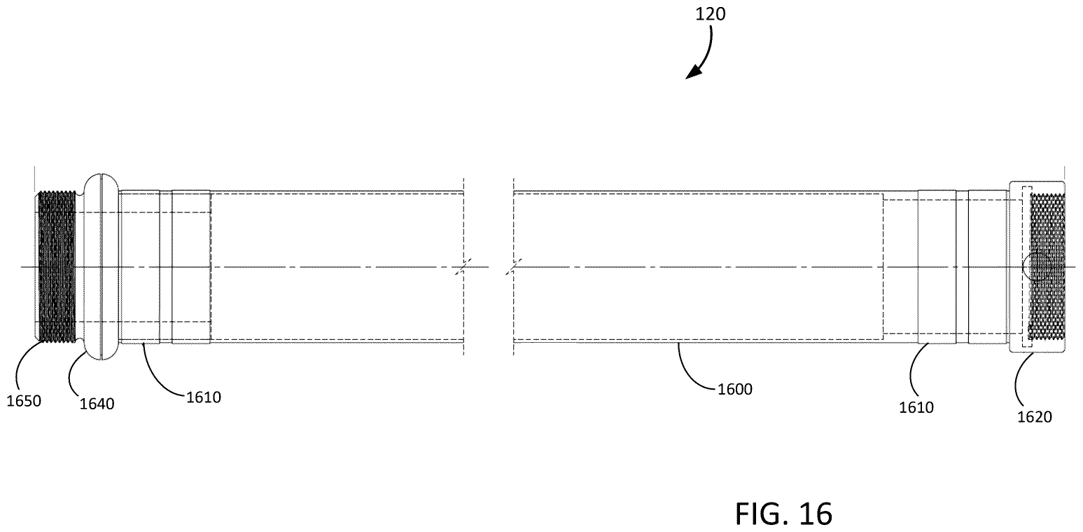

Now that various deployment methods have been discussed in considerable detail, attention will be focused on the hose system capable of delivering these improved fire suppression systems. FIG. 16 provides a cross-sectional view of the traditional fire hose system 120. This type of fire hose system 120 is leveraged widely, and has been standardized in order to match standardized fittings on fire hydrants and fire trucks. The primary components of the traditional fire hose includes a rubber interior and woven cotton protective exterior hose segment 1600. These hoses may vary in length, but often come in standardized sizes, with the most common length being 50 ft.

The hose body 1600 is coupled to two different adapters, one on each end. The adapters include a male adapter 1650 and a female adapter 1620. These fittings may be threaded in order to enable the hose 120 to be coupled to the fire hydrant, another hose, the nozzle system, a fire truck, an adapter such as the CIAC assembly 150, or other adapter (such as a valve segment). The male adapter 1650 and the female adapter 1620 consist of a rigid material to allow for connections to other adapters. Most commonly these adapters are comprised of steel or another metal. Metal bandings 1610 crimp the hose body 1600 to the adapters 1650 and 1620, thereby preventing leakage and ensuring structural fidelity when in use. A collar 1640 is seen near the male adapter 1650 to allow for leverage when tightening the adapters.

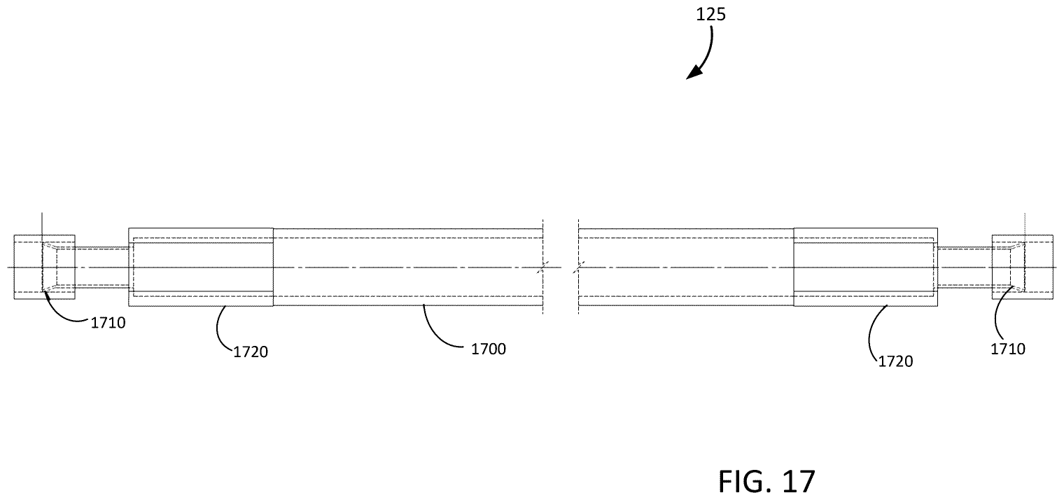

In contrast, FIG. 17 illustrates the cryo-tube, or intercoupling inner coolant hose 125, in a cross-sectional view. This hose generally extends marginally longer than a standardized fire hose 120. In some particular embodiments, the length of the inner coolant hose 125 is approximately three inches longer than the outer fire hose. Unlike the fire hose 120, the inner coolant hose 125 is reversible, that is the threading is identical on each flared female adapter 1710 on each end of the hose. However, it is contemplated in some embodiments that the inner coolant hose 125 may indeed be polar, e.g., that one end of the hose terminated in a male adapter and the other end in a female adapter. More so, it is possible that in some embodiments an intermediate adapter may be present that converts one of the hose's female adapters to a male adapter. In yet other embodiments, The flared ends of the inner coolant hose 125 are not threaded at all and instead include gaskets allowing for the inner coolant hose to be push connected on either end.

The inner coolant hose 125 also possesses a rigid section 1720, coupled to the hose body 1700. This rigid section ensures that the inner coolant hose is structurally stable during connection and release of the hose assembly when it is being connected to an adapter, another hose, or to a nozzle element.

The main body of the coolant hose 125 may consist of a thin-walled steel tubing 1700. The steel tubing may be thick enough to prevent rupture due to the high pressure of the liquid coolant, yet be flexible enough to allow for some movement of the tube 1700. Often fire hoses must be curved around corners or over obstacles, and it is important that the tube 1700 remains flexible enough to accommodate such curvature. To that end, in some specific embodiments, the tube 1700 may be a corrugated steel tubing to increase flexibility. In yet other embodiments, the coolant tube 1700 may instead include a rubberized interior with braided steel sheathing material for strength. Rupture resistance is of paramount importance to the tubing design, as the traditional fire hose is ill equipped to deal with the elevated pressure that the liquid coolant is under. A rupture of the inner coolant hose 125 could result in the fire hose 120 also rupturing, which would defeat the purpose of rapid fire suppression.

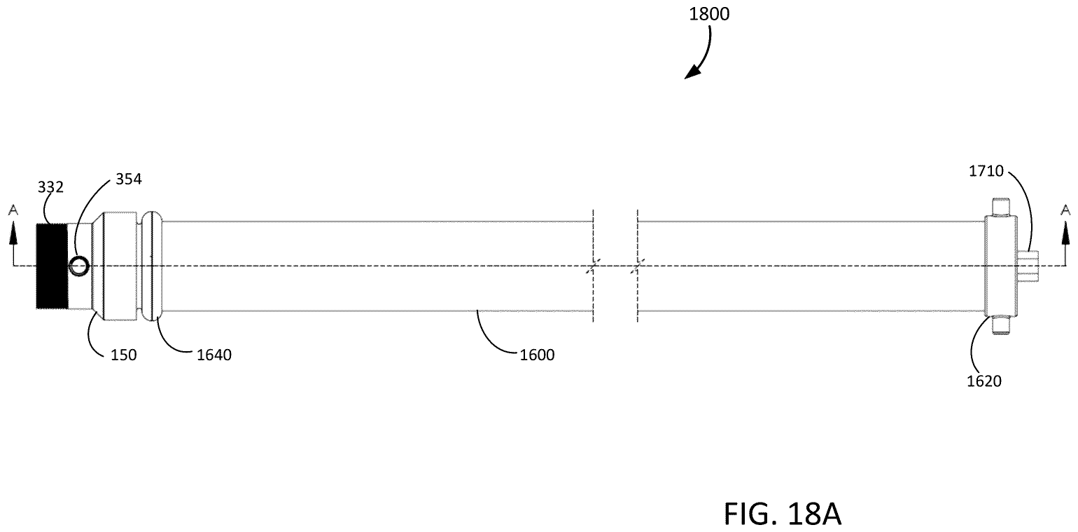

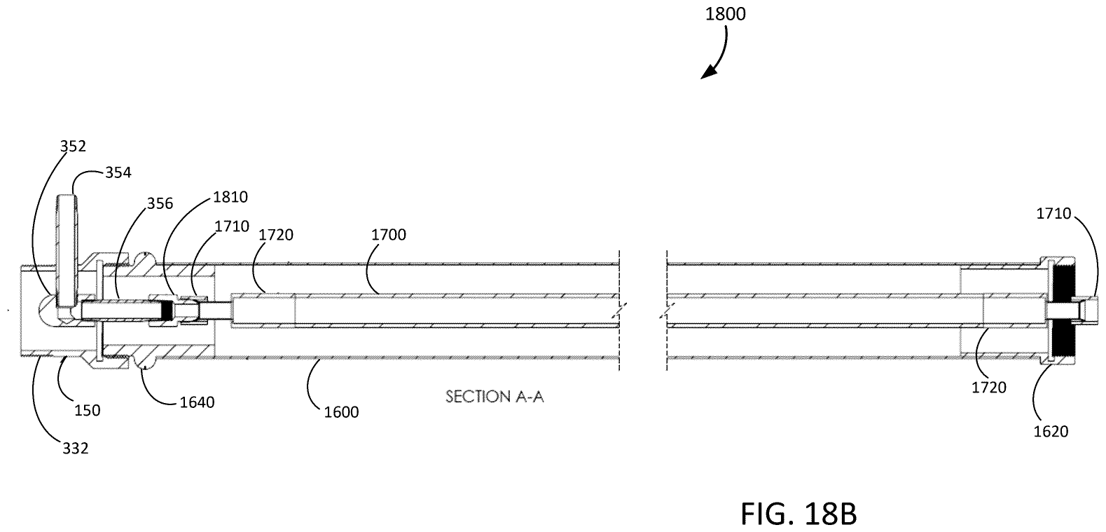

FIG. 18A provides a side view of the full hose assembly 1800. Here the outer fire hose 120 is visible coupled to the CIAC assembly 150. The CIAC assembly 150 still includes the coolant tank feed pipe 354 and the external threads 332. Not visible in this figure, the threaded section 336 of the CIAC couples with the threads of the male adapter 1650 of the fire hose 120. The collar 1640 is visible.

On the other end of the hose assembly 1800, the flared female adapter 1710 is seen extending from the end of the hose assembly 1800. This adapter may be coupled to another hose, or to the coolant inlet pipe 358 of the nozzle assembly 110. The female adapter 1620 of the fire hose 120 may then also be coupled to the next hose segment or the nozzle assembly 110.

FIG. 18B provides a more detailed cross-sectional view along A-A of FIG. 18A. As seen before, the coolant tank feed pipe 354 extends within the CIAC assembly 150 to the coolant elbow 352. The coolant then flows into the coolant supply pipe 356 to an intermediate adapter 1810. The intermediate adapter ensures the length between the CIAC assembly 150 and the coolant hose 125 is correct and ensures a leak-proof joining. The collar 1640 of the fire hose is used to screw in the threaded portion of the male adapter 1640 of the fire hose 120 into the CIAC assembly 150. The coolant then passes through the rigid section 1720 of the inner coolant hose 125, through the tubing 1700, and finally out the opposite end where there is the other rigid section 1720 coupled to a flared fitting 1710. Simultaneously, water is flowing through the main tube 1600 of the fire hose 120 coaxially to the coolant. The water and coolant are thus delivered to the CISN assembly 110 that is described in significant detail above.

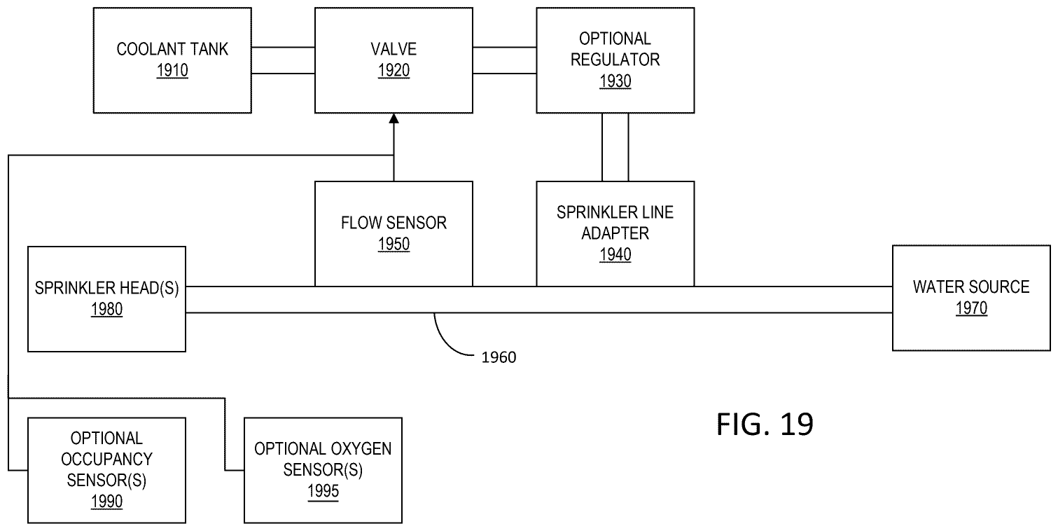

Moving on, while portable fire suppression systems have been described herein in considerable detail, a permanent fire suppression apparatus is also contemplated by this disclosure, by way of a built-in-place architectural sprinkler system. FIG. 19 provides a block diagram of the constituent parts of such a system. As with a portable system, a coolant tank 1910 is necessary for the operation of the coolant infused stationary fire suppression system. The coolant tank is connected to a valve 1920 that rather than manual operation, as with the portable systems, may be triggered by a number of sensors, as will be disclosed later in this description. Optionally, a regulator 1930 may exist either before or after the valve 1920 in order to control the pressure of the coolant through the sprinkler system. As the sprinklers are likely designed with standard steel sprinkler piping, it is important that the pressure within these sprinkler lines remains within tolerance. Lastly, the coolant may travel to a sprinkler line adapter 1940 which connects the coolant line directly to the sprinkler system 1960. Generally, the coolant line couples to the sprinkler system 1960 closer to the water source 1970; before the sprinkler system branches into individual nodes throughout the structure. This ensures that the cooled and frothed mixture is evenly distributed throughout the sprinkler lines 1960 and to each applicable sprinkler head 1980.

A flow sensor 1950 monitors either flow or pressure of the sprinkler lines 1960 to determine when water is flowing (e.g., when a fire is present). Sprinkler heads 1980 are generally sealed with a glass bulb or other triggering mechanism that allows water to flow when a fire is detected. In some cases, the glass bulb melts in the presence of sufficient heat, allowing water to flow. This flow is detected by the sensor 1950 and relayed back to the valve 1920 to cause the coolant to be injected into the sprinkler lines 1960.

As noted before, the coolant-water mixture suppresses fires faster than ambient temperature water alone through two primary mechanisms. Firstly, the flowing water is significantly cooled, allowing for the mixture to reduce the fuel temperature below the flashpoint faster. Secondly, the fact that the coolant is a liquid inert gas, such as liquid nitrogen, means that the combustion chemical reaction may be compromised because the expanding nitrogen gas displaces the oxygen leading to a smothering effect. This is extremely powerful when suppressing a fire, but may result in a health hazard if an occupant is present in the room. Lack of oxygen can cause a person to faint or become disoriented. In extreme cases, lack of oxygen can result in death. Thus, in some embodiments, the system may employ an optional occupancy sensors 1990 and/or optional oxygen sensors 1995 that couple to the valve. The occupancy sensors 1990 may prevent or disable the valve 1920 from releasing the coolant into the sprinkler system 1960 unless no occupants are detected. Occupancy sensors may leverage motion sensors, optical sensors, and the like. In contrast, Oxygen sensors 1995 may modulate coolant (as opposed to turning the system completely off) to maintain a base level of oxygen in the environment. In some embodiments, the oxygen sensor 1995 may ensure that a minimum of anywhere between 13-17% oxygen remains in the air. Such levels may make breathing more labored, but are above the danger zone for humans, and ensures the fire suppression system still operates in an optimal manner.

In sum, the present invention provides systems and methods for infusing a coolant into a fire suppressing water stream thereby substantially reducing the temperature of the water stream and causing a displacement of oxygen leading to a smothering impact on the fire. The advantages of such a system include the ability to more rapidly suppress and/or extinguish a fire with the same or less volume of water. Additionally, since the coolant is an inert liquid gas, there is no significant additional cleanup associated with its deployment, unlike foam-based fire suppression systems.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention. In addition, where claim limitations have been identified, for example, by a numeral or letter, they are not intended to imply any specific sequence.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A fire suppression system configured to provide a mixture of coolant and water, the fire suppression system comprising:
a coaxial coolant infusion hose assembly comprising:
an outer fire hose comprising:
a male adapter configured to reversibly couple to water source, a coolant introduction adapter or a second outer fire hose;
a female adapter configured to reversibly couple to a nozzle assembly or a third fire hose; and
a main hose body coupled to the male adapter and the female adapter, wherein water is configured to flow through the male adapter, through the main hose body and out the female adapter;
an inner coolant hose comprising a pair of female fittings coupled together by a coolant tube, wherein the inner coolant hose fits coaxially within the outer fire hose, and wherein the inner coolant hose is longer than the outer fire hose, and wherein coolant flows through the inner coolant hose.

2. The fire suppression system of claim 1 wherein the coolant from a coolant source includes liquid nitrogen.

3. The fire suppression system of claim 1 wherein the male adapter and the female adapter are 2.5″ threaded adapters.

4. The fire suppression system of claim 1 wherein one of the female fittings is configured to reversibly couple to a coolant injection adapter.

5. The fire suppression system of claim 4 wherein the other female fitting is configured to couple to a Coolant Infusion Spray Nozzle (CISN) assembly, wherein the CISN assembly further comprises a nozzle housing configured to house the coolant infuser, and wherein the coolant is infused into the water inside a mixing chamber within the nozzle housing.

6. The fire suppression system of claim 1 wherein the inner coolant hose is approximately three inches longer than the outer fire hose.

7. The fire suppression system of claim 1 wherein the coolant tube is a solid steel tubing.

8. The fire suppression system of claim 7 wherein the solid steel tubing is thin walled, allowing for the inner coolant hose to remain partially flexible.

9. The fire suppression system of claim 1 wherein the coolant tube is a braided steel hose with an inner rubber tube.

10. The fire suppression system of claim 1 further comprising a Coolant Introduction Adapter Cap (CIAC) assembly configured to supply the water and the coolant to the coaxial coolant infusion hose assembly, and wherein the CIAC assembly includes:
a housing having a first interface and a second interface, wherein the first interface is configured to operatively couple the CIAC assembly to a water source, and wherein the second interface is configured to operatively couple the CIAC assembly to the coaxial coolant infusion hose assembly; and
a coolant elbow configured to direct the coolant from the coolant source toward the coaxial coolant infusion hose assembly.

11. A fire suppression system configured to provide a mixture of coolant and water, the fire suppression system comprising:
a coolant tank coupled to a coolant line;
a coolant line valve coupled to the coolant line;
a coolant line adapter coupled to the coolant line and a building sprinkler system;
a flow sensor disposed in the building sprinkler system, wherein the flow sensor detects the flow of water through the building sprinkler system and causes the coolant line valve to open, thereby releasing coolant from the coolant source, through the coolant line and into the building sprinkler system; and
at least one sprinkler head for releasing the water and coolant mixture into a building where a flame is present.

12. The fire suppression system of claim 11 wherein the coolant from the coolant tank includes liquid nitrogen.

13. The fire suppression system of claim 11 further comprising a regulator disposed in the coolant line, wherein the regulator restricts the coolant flow.

14. The fire suppression system of claim 13 wherein the regulator is a dynamic regulator that varies the flow of coolant into the sprinkler system responsive to water flow rate.

15. The fire suppression system of claim 14 wherein more coolant is released into the sprinkler system as the water flow rate increases.

16. The fire suppression system of claim 11 further comprising at least one of at least one occupancy sensor and oxygen sensor disposed near each sprinkler head.

17. The fire suppression system of claim 16 wherein the at least one of the at least one occupancy sensor and oxygen sensor couples to the coolant valve, and wherein when the occupancy sensor detects a human in the building, it prevents the coolant valve from releasing the coolant into the sprinkler system, and wherein the oxygen sensor modulates the coolant valve to maintain between 13-17% oxygen in the environment.

18. The fire suppression system of claim 17 wherein the occupancy sensor is a motion detector.

19. The fire suppression system of claim 18 wherein the occupancy sensor is an optical system.

20. A method for deploying a fire suppression system comprising:
sensing the flow of water in a fire suppression building sprinkler system;
sensing if a human is located near a sprinkler head of the fire suppression building sprinkler system;
when water is sensed flowing and the human is located near the sprinkler head, keeping a valve to a coolant tank closed; and
when water is sensed flowing and no human is located near the sprinkler head, opening the valve to the coolant tank.
